(19) United States
(12) Patent Application Publication
(10) Pub. No.: US 2024/0282206 A1
(43) Pub. Date: Aug. 22, 2024

(54) INFORMATION OUTPUT METHOD, INFORMATION OUTPUT DEVICE, AND NON-TRANSITORY COMPUTER READABLE RECORDING MEDIUM

(71) Applicant: Panasonic Intellectual Property Corporation of America, Torrance, CA (US)

(72) Inventor: Kihiro YUASA, Kanagawa (JP)

(73) Assignee: Panasonic Intellectual Property Corporation of America, Torrance, CA (US)

(21) Appl. No.: 18/650,349

(22) Filed: Apr. 30, 2024

Related U.S. Application Data
(63) Continuation of application No. PCT/JP2022/038018, filed on Oct. 12, 2022.

(30) Foreign Application Priority Data
Nov. 4, 2021 (JP) 2021-180344

(51) Int. Cl. G09B 5/02; G06V 20/40

(52) U.S. Cl. CPC G09B 5/02; G06V 20/41

(57) ABSTRACT

This information output device acquires cooking information including cooking content to be evaluated and an instruction level of an instructor, generates assistance information when the instructor instructs, in cooking, a cook who is executing the cooking content based on the cooking information and the instruction level, and outputs the assistance information.

### FIELD OF INVENTION

The present disclosure relates to a technology to assist cooking instruction.

### BACKGROUND ART

Patent Literature 1 discloses a cooking learning assistance system that presents necessary cooking learning information according to the cooking skill of a cook in proper quantities. In this cooking learning assistance system, the learning level of a specific cook in a cooking element is read, learning information according to the learning level of the specific cook in the cooking element is read for each cooking process, and the read learning information is presented together with the cooking process.

However, since Patent Literature 1 does not disclose the presentation of information according to the level of the person teaching cooking, further improvements are needed for the instructor to provide the cook with appropriate cooking instruction.

Patent Literature 1: WO 2021/014910 A

### SUMMARY OF THE INVENTION

The present disclosure has been made to solve these problems, and an object is to provide the technology to cause the instructor to instruct the cook in cooking appropriately.

An information output method according to one aspect of the present disclosure includes, by a computer: acquiring cooking information including cooking content to be evaluated and an instruction level of an instructor; generating assistance information when the instructor instructs, in cooking, a cook who executes the cooking content based on the cooking information and the instruction level; and outputting the assistance information.

The present disclosure allows the instructor to provide the cook with appropriate cooking instruction.

### BRIEF DESCRIPTION OF THE DRAWINGS

FIG. 1 is a diagram showing one example of an overall configuration of an information output system according to the present embodiment.

FIG. 2 is a block diagram showing one example of a configuration of an information output device shown in FIG. 1.

FIG. 3 is a diagram showing data structure of a lecture information table according to one example of the present embodiment.

FIG. 4 is a diagram showing detailed contents of a lecture A shown in FIG. 3.

FIG. 5 is a diagram showing detailed contents of a lecture B shown in FIG. 3.

FIG. 6 is a diagram showing detailed contents of a lecture C shown in FIG. 3.

FIG. 7 is a diagram showing data structure of an evaluation result table of a first example of the present embodiment.

FIG. 8 is a diagram showing data structure of an evaluation result table of a second example of the present embodiment.

FIG. 9 is a diagram showing one example of data structure of a first generation table.

FIG. 10 is a diagram showing one example of data structure of a second generation table.

FIG. 11 is a flowchart showing one example of processing of the information output system shown in FIG. 1.

FIG. 12 is a flowchart following FIG. 11.

FIG. 13 is a flowchart showing one example of processing of the information output device.

FIG. 14 is a diagram showing a food material determination screen of the first example of the present embodiment.

FIG. 15 is a diagram showing the food material determination screen of the second example of the present embodiment.

FIG. 16 is a flowchart showing details of instruction level determination processing.

FIG. 17 is a diagram showing a cooking utensil selection screen according to the first example of the present embodiment.

FIG. 18 is a diagram showing the cooking utensil selection screen according to the second example of the present embodiment.

FIG. 19 is a diagram showing a display screen of second lecture information.

FIG. 20 is a diagram showing the display screen of first lecture information.

FIG. 21 is a diagram showing a display screen of auxiliary information.

FIG. 22 is a diagram showing a display screen of third evaluation assistance information.

FIG. 23 is a diagram showing the display screen of second evaluation assistance information.

FIG. 24 is a diagram showing a display screen of a first example of first evaluation assistance information.

FIG. 25 is a diagram showing the display screen of a second example of the first evaluation assistance information.

FIG. 26 is a diagram showing one example of a lecture information determination table for determining lecture information.

### DETAILED DESCRIPTION

### Knowledge Underlying Present Disclosure

While some children develop an interest in cooking through experience in cooking, such as cooking classes, some parents are anxious about entrusting cooking to their children. Therefore, there may be a gap between actual cooking skills of their children and cooking skills of their children that their parents believe they have. Such a gap makes it difficult for the parents to provide appropriate instruction according to the cooking skills of their children. Therefore, a system that provides instructional assistance when the parents instructs their children in cooking is useful.

However, since the instruction level of the parents who provide cooking instruction varies depending on the parents, if the same instructional assistance is uniformly provided without considering the instruction level of the parents, the parents will not be able to provide their children with appropriate cooking instruction. For example, providing considerate instructional assistance such as explaining in detail cooking instruction points to parents with the high instruction level will rather hinder the parents from providing smooth cooking instruction. Meanwhile, providing weak instructional assistance to parents with the low instruction level will disable the parents from understanding the instruction points and providing appropriate cooking instruction.

In the above conventional technology, the cooking level of the cook is considered, but the instruction level of the instructor is not considered. Therefore, the instructor cannot provide the cook with appropriate instruction.

The present disclosure has been made in order to solve such a problem.

(1) An information output method according to one aspect of the present disclosure includes, by a computer: acquiring cooking information including cooking content to be evaluated and an instruction level of an instructor; generating assistance information when the instructor instructs, in cooking, a cook who executes the cooking content based on the cooking information and the instruction level; and outputting the assistance information.

With this configuration, the cooking information including the cooking content to be evaluated and the instruction level of the instructor in cooking are acquired, the assistance information when the instructor instructs the cook in the cooking content is generated based on the acquired instruction level, and the generated assistance information is output. In this way, this configuration, which generates the assistance information according to the instruction level of the instructor, can cause the instructor to instruct the cook in cooking appropriately.

(2) In the information output method according to (1) described above, the cooking information may further include cooking utensil information indicating a cooking utensil used for the cooking, and the cooking content may include food material information indicating a food material used for the cooking.

With this configuration, the cooking information includes the cooking utensil information indicating the cooking utensil used for the cooking, and the cooking content includes the food material information indicating the food material to cook, making it possible to present the assistance information that is appropriate for at least one of the cooking utensil and the food material to the instructor.

(3) In the information output method according to (1) or (2) described above, the cooking content may include at least one of an action of cutting the food material, an action of boiling the food material, and an action of grilling the food material.

With this configuration, it is possible to present the assistance information that is appropriate for at least one of the action of cutting the food material, the action of boiling the food material, and the action of grilling the food material to the instructor.

(4) In the information output method according to any one of (1) to (3) described above, the instruction level may be determined based on at least one of execution experience of the instructor in the cooking content, and a comprehension level of the instructor about instruction content when instructing the cook in the cooking.

With this configuration, it is possible to determine the instruction level appropriately because the instruction level is determined based on at least one of the execution experience of the instructor in the cooking content, and the comprehension level of the instructor about the instruction content when instructing the cook in the cooking.

(5) In the information output method according to any one of (1) to (4) described above, when the instructor does not have the execution experience of the cooking content, the generated assistance information may include the cooking content and the instruction content when instructing the cook in the cooking.

With this configuration, when the instructor does not have the execution experience of the cooking content, the assistance information including the cooking content and instruction content is generated, making it possible to present appropriate assistance information to the instructor who does not have the execution experience of the cooking content.

(6) The information output method according to any one of (1) to (5) described above further includes acquiring a comprehension level of instruction content by the cook when the instructor has execution experience of the cooking content, in which when the comprehension level is equal to or less than a predetermined value, the generated assistance information may include the instruction content, and when the comprehension level is greater than the predetermined value, the assistance information may not be generated.

With this configuration, in a case where the comprehension level of the instructor when instructing the cook in the cooking is equal to or less than a predetermined value, the assistance information including the instruction content is generated, making it possible to cause the instructor with the low comprehension level to understand the instruction content. Meanwhile, with this configuration, when the comprehension level of the instructor is higher than the predetermined value, the assistance information including the cooking content and the instruction content is not generated, making it possible to prevent presentation of unnecessary assistance information that hinders smooth instruction to the instructor with the high instruction level.

(7) The information output method according to any one of (1) to (6) described above may further include: acquiring execution information including a video photographed while the cook executes the cooking; generating evaluation assistance information including the execution information based on the instruction level; and outputting the evaluation assistance information.

With this configuration, the execution information including the video photographed while the cook executes the cooking is acquired, the evaluation assistance information including the execution information is generated based on the instruction level, and the generated evaluation assistance information is output, thereby allowing the instructor to evaluate the cook smoothly.

(8) The information output method according to any one of (1) to (7) described above may further include acquiring experience information indicating whether the instructor has execution experience of the cooking content, in which in generation of the evaluation assistance information, when the experience information indicates that the instructor does not have the execution experience, the generated evaluation assistance information may include the cooking content, the instruction content of the cooking by the instructor, and the execution information.

With this configuration, when the instructor does not have the execution experience of the cooking content, the evaluation assistance information including the cooking content, the instruction content, and the execution information is presented, making it possible to present the evaluation assistance information that allows the instructor who does not have the execution experience to evaluate the cook appropriately.

(9) The information output method according to any one of (1) to (8) described above may further include acquiring a comprehension level of the instruction content by the instructor when the experience information indicates that the instructor has the execution experience, in which when the comprehension level is equal to or less than a predetermined value, the generated evaluation assistance information may include the instruction content and the execution information.

With this configuration, the evaluation assistance information including the instruction content and the execution information is presented to the instructor whose comprehension level of the instruction content is equal to or less than a predetermined value, making it possible to present the evaluation assistance information that allows the instructor whose comprehension level of the instruction content is equal to or less than a predetermined value to evaluate the cook appropriately.

(10) In the information output method according to any one of (1) to (9) described above, outputting the assistance information may include outputting the assistance information while the cook executes the cooking content, and outputting the evaluation assistance information may include outputting the evaluation assistance information after the cook executes the cooking content.

With this configuration, the assistance information is output while executing the cooking content, allowing the instructor to instruct the cook while referring to the assistance information during execution of the cooking content. Meanwhile, with this configuration, the evaluation assistance information is output after executing the cooking content, making it possible to evaluate the cook while looking back the cooking content of the cook with reference to the evaluation assistance information.

(11) The information output method according to any one of (1) to (10) described above may further include: acquiring an evaluation result of the cook by the instructor based on the evaluation assistance information; and storing the evaluation result in a memory in association with the cooking content.

With this configuration, the evaluation result of the cook by the instructor based on the evaluation assistance information is stored in a memory in association with the cooking content, making it possible to record the evaluation result of the cooking content.

(12) In the information output method according to any one of (1) to (11) described above, acquiring the cooking information may include: presenting at least one of the cooking content of which the cook does not have execution experience and cooking content of which evaluation by the instructor is an unachieved evaluation; and acquiring cooking information including cooking content selected based on the cooking content presented.

With this configuration, the cooking content is selected from at least one of the cooking content of which the cook does not have the execution experience and the cooking content of which evaluation by the instructor is an unachieved evaluation, and the cooking information including the selected cooking content is acquired. Therefore, it is possible to cause the cook to execute this cooking content, and to efficiently improve the cooking skill of the cook.

(13) The information output method according to any one of (1) to (12) described above may further include acquiring a cooking level of the cook, in which generating the assistance information may include generating the assistance information based on the cooking information, the instruction level, and the cooking level.

With this configuration, it is possible to generate appropriate assistance information according to the cooking level of the cook and the instruction level of the instructor.

(14) An information output device according to another aspect of the present disclosure includes: an acquisition unit that acquires cooking information including cooking content to be evaluated and an instruction level of an instructor; a generation unit that generates assistance information when the instructor instructs, in cooking, a cook who executes the cooking content based on the cooking information and the instruction level; and an output unit that outputs the assistance information.

With this configuration, it is possible to apply the information output device that can produce the same effects as the information output method described above.

(15) An information output program according to another aspect of the present disclosure causes a computer to execute processing including: acquiring cooking information including cooking content to be evaluated and an instruction level of an instructor; generating assistance information when the instructor instructs, in cooking, a cook who executes the cooking content based on the cooking information and the instruction level; and outputting the assistance information.

With this configuration, it is possible to apply the information output device that can produce the same effects as the information output method described above.

The present disclosure can also be implemented as an information output system that operates by such an information output program. It is needless to say that such a computer program can be distributed via a computer-readable non-transitory recording medium such as a CD-ROM, or via a communication network such as the Internet.

Note that an embodiment described below shows one specific example of the present disclosure. Numerical values, shapes, constituents, steps, order of steps, and the like shown in the embodiment below are merely one example, and are not intended to limit the present disclosure. Furthermore, a constituent that is not described in an independent claim representing the highest concept among constituents in the embodiment below is described as an arbitrary constituent. In all the embodiments, respective contents can be combined.

### Embodiment

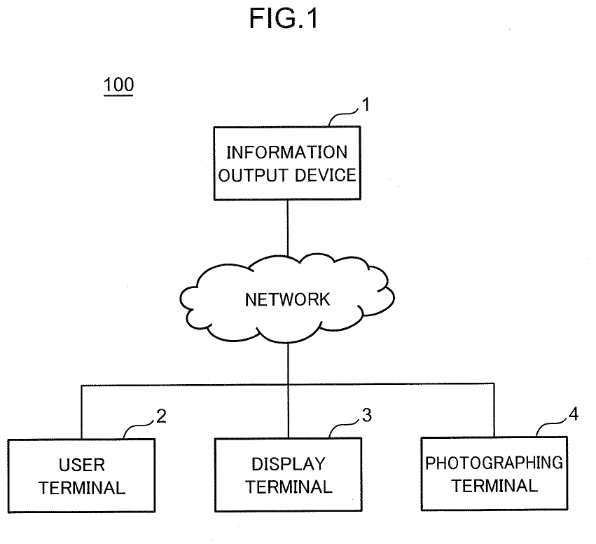

The embodiment of the present disclosure will be described below. FIG. 1 is a diagram showing one example of an overall configuration of an information output system 100 according to the present embodiment. The information output system 100 includes an information output device 1, a user terminal 2, a display terminal 3, and a photographing terminal 4. The information output device 1, the user terminal 2, the display terminal 3, and the photographing terminal 4 are connected to allow communication with each other via a network. The network is, for example, a wide-area communication network including the Internet and a mobile phone communication network.

The information output device 1 is, for example, a cloud server including one or more computers. The information output device 1 acquires cooking information from the user terminal 2, generates lecture information (one example of assistance information) based on the acquired cooking information, and transmits the generated lecture information to the display terminal 3.

The user terminal 2 is, for example, a portable information processing device such as a tablet computer and a smartphone. The user terminal 2 receives the input of the cooking information from the user, and transmits the received cooking information to the information output device 1. The display terminal 3 is, for example, a portable information processing device, in a similar manner to the user terminal 2. The display terminal 3 displays the lecture information on the display. The photographing terminal 4 is, for example, a camera installed in a kitchen. The photographing terminal 4 is installed at a position where, for example, the cook's hands can be photographed from above a cooking table in the kitchen. The photographing terminal 4 captures an image including the hands of the user who is cooking on the cooking table at a predetermined frame rate, and transmits the image to the information output device 1. Note that the photographing terminal 4 may be installed at any position as long as the hands of the cook can be photographed. For example, the photographing terminal 4 may be installed at a position where the hands of the cook can be photographed from a lateral angle.

The user terminal 2 and the display terminal 3 may be integrally configured. The user terminal 2 and the display terminal 3 may include stationary information processing devices. The photographing terminal 4 may include a portable information processing device including a camera. The photographing terminal 4 may be configured integrally with at least one of the user terminal 2 and the display terminal 3.

The user includes a cook who cooks food and an instructor who provides the cook with instruction in the cooking content. One example of the cook is a child, and one example of the instructor is the child's guardian such as the child's mother and father. This is one example, and the cook may be an adult with little cooking experience, and the instructor may be an adult or child with extensive cooking experience who provides the adult with cooking instruction. Both the cook and the instructor may be children. In this case, one example of the cook is a younger sister or younger brother, and one example of the instructor is an older sister or older brother.

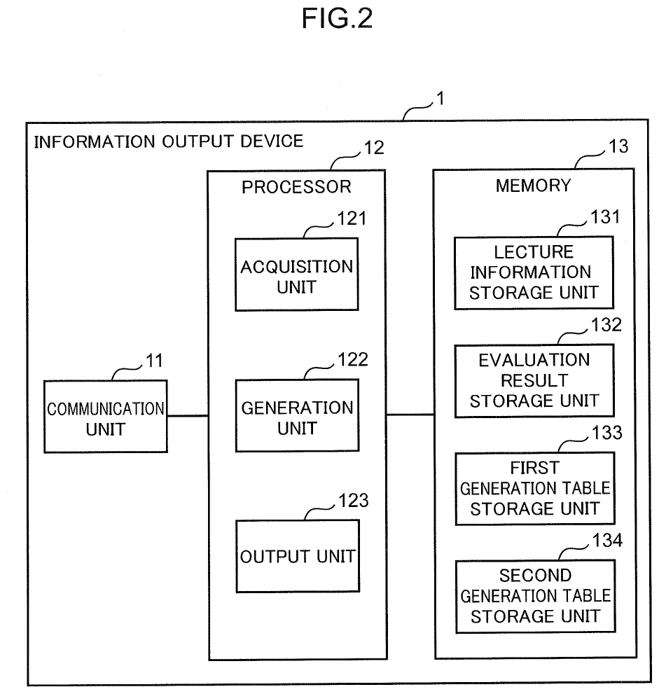

FIG. 2 is a block diagram showing one example of the configuration of the information output device 1 shown in FIG. 1. The information output device 1 includes a communication unit 11, a processor 12, and a memory 13. The communication unit 11 is, for example, a communication circuit that connects the information output device 1 to the network. The communication unit 11 receives, for example, food material information and instructor information from the user terminal 2. The communication unit 11 transmits the lecture information to the display terminal 3, for example.

The processor 12 includes, for example, a central processing unit (CPU). The processor 12 includes an acquisition unit 121, a generation unit 122, and an output unit 123. The acquisition unit 121 to the output unit 123 are implemented by the CPU executing an information output program. The acquisition unit 121 to the output unit 123 may each include a dedicated integrated circuit such as an application specific integrated circuit (ASIC).

The acquisition unit 121 acquires the cooking information including the cooking content to be evaluated. One example of the cooking content is an action of cutting a food material. In addition to the cooking content, the cooking information further includes cooking utensil information indicating a cooking utensil used for cooking. The cooking content further includes food material information indicating the food material used for cooking. One example of the cooking utensil is a tool for cutting a food material, such as a kitchen knife, peeler, grater, and slicer, and a tool for heating a food material such as a frying pan, gas stove, IH stove, and microwave oven. One example of the food material is a vegetable that requires cutting for cooking, such as tomato, onion, carrot, cucumber, eggplant, Japanese radish, and potato. One example of the food material is fruit that requires cutting for cooking, such as banana, apple, watermelon, melon, strawberry, kiwi, pear, and peach.

Furthermore, the acquisition unit 121 acquires the instruction level of the instructor. Here, the acquisition unit 121 may acquire the instruction level the instructor has input to the user terminal 2 from the user terminal 2. In the following description, the acquisition unit 121 acquires the instructor information on the instructor to determine the instruction level based on the acquired instructor information. The instructor information includes experience information and a comprehension level of instruction content. The experience information is information indicating whether the instructor has experience in cooking the food material to be instructed. The comprehension level of the instruction content is information indicating the extent to which the instructor understands the instruction content for the food material to be instructed.

The instruction level includes, for example, the high level, the medium level, and the low level. The acquisition unit 121 determines that the instruction level is the low level when the experience information indicates no cooking experience. The acquisition unit 121 determines that the instruction level is the medium level when the experience information indicates some cooking experience and the comprehension level of the instruction content is equal to or less than a first predetermined value. The acquisition unit 121 determines that the instruction level is the high level when the experience information indicates some cooking experience and the comprehension level of the instruction content by the instructor is higher than the first predetermined value.

Furthermore, the acquisition unit 121 acquires execution information including a cooking video photographed by the photographing terminal 4 while the cook executes cooking. The cooking video is a video showing how the cook executes cooking. The cooking video is, for example, a video showing how the cook cooks the food material by using the cooking utensil.

The generation unit 122 generates the lecture information when the instructor provides the cook who executes the cooking content with cooking instruction, based on the cooking information and the instruction level acquired by the acquisition unit 121. For example, when the instruction level of the cook is the low level, the generation unit 122 generates first lecture information that is lecture information including the cooking content and the instruction content when providing the cook with cooking instruction (one example of assistance information).

For example, when the instruction level of the instructor is the medium level, the generation unit 122 generates second lecture information that is lecture information that includes the instruction content and does not include the cooking content (one example of assistance information).

For example, when the instruction level of the instructor is the high level, the generation unit 122 does not generate the first lecture information and the second lecture information. In this case, the generation unit 122 may generate auxiliary information that does not include the cooking content and the instruction content.

Furthermore, the generation unit 122 generates evaluation assistance information including the execution information acquired by the acquisition unit 121, based on the instruction level acquired by the acquisition unit 121. The evaluation assistance information is information for assisting evaluation when the instructor evaluates the cooking content executed by the cook.

For example, when the instruction level of the instructor is the low level, the generation unit 122 generates first evaluation assistance information, which is evaluation assistance information including the cooking content, the instruction content in cooking by the instructor, and the execution information.

For example, when the instruction level of the instructor is the medium level, the generation unit 122 generates second evaluation assistance information, which is evaluation assistance information that includes the cooking instruction content and the execution information by the instructor and does not include the cooking content.

For example, when the instruction level of the instructor is the high level, the generation unit 122 generates third evaluation assistance information, which is evaluation assistance information that includes only the execution information.

The output unit 123 outputs the lecture information and the evaluation assistance information. For example, the output unit 123 outputs the lecture information and the evaluation assistance information by transmitting the lecture information and the evaluation assistance information to the user terminal 2 and or the display terminal 3 by using the communication unit 11. For example, the output unit 123 outputs the assistance information while the cook is executing the cooking content. For example, the output unit 123 outputs the evaluation assistance information after the cook executes the cooking content.

The memory 13 includes a rewritable nonvolatile storage device such as a hard disk drive and a solid state drive. The memory 13 includes a lecture information storage unit 131, an evaluation result storage unit 132, a first generation table storage unit 133, and a second generation table storage unit 134.

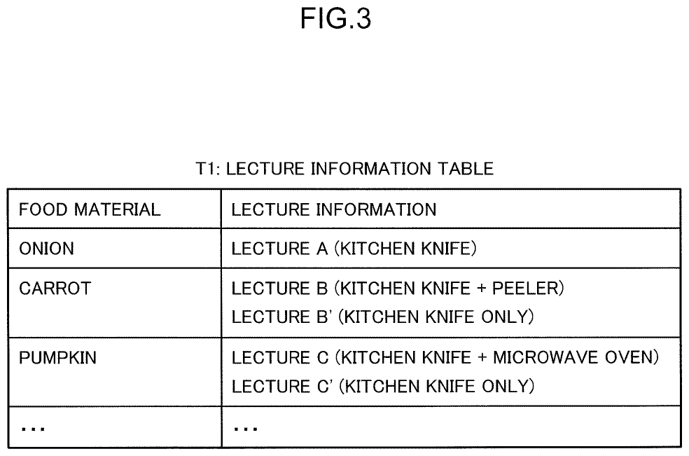

The lecture information storage unit 131 stores a lecture information table T1 (FIG. 3). FIG. 3 is a diagram showing data structure of the lecture information table T1 according to one example of the present embodiment. The lecture information table T1 records the lecture information for each food material. For example, the lecture A is lecture information when cutting an onion with a kitchen knife, the lecture B is lecture information when cutting a carrot with a kitchen knife and a peeler, the lecture B′ is lecture information when cutting a carrot with only a kitchen knife, the lecture C is lecture information when cooking a pumpkin with a kitchen knife and microwave oven, and the lecture C′ is lecture information when cutting a pumpkin with only a kitchen knife. In this way, the lecture information has content corresponding to the combination of the food material and the cooking utensil information. This makes it possible to provide the instructor with more fine-grained instructional assistance. The lecture information includes a video and checkpoint. The video is, for example, a moving image, a still image, an illustration, or the like obtained by photographing a model cooking scene. The checkpoint is a point the instructor should check when providing instruction.

The lecture information may be created and uploaded by the user (instructor). For example, one example of the lecture information to be uploaded is lecture information created by the instructor (mother) (including moving image, still image, illustration, and checkpoint). This allows the instructor to provide smoother instruction by using the lecture information created by the instructor. One example of the lecture information to be uploaded may be information with which the instructor provides a child with instruction in the cooking content, based on the lecture information created by a person (for example, mother) different from the instructor who has little cooking experience (for example, father). This allows the instructor who has little cooking experience to provide smoother instruction.

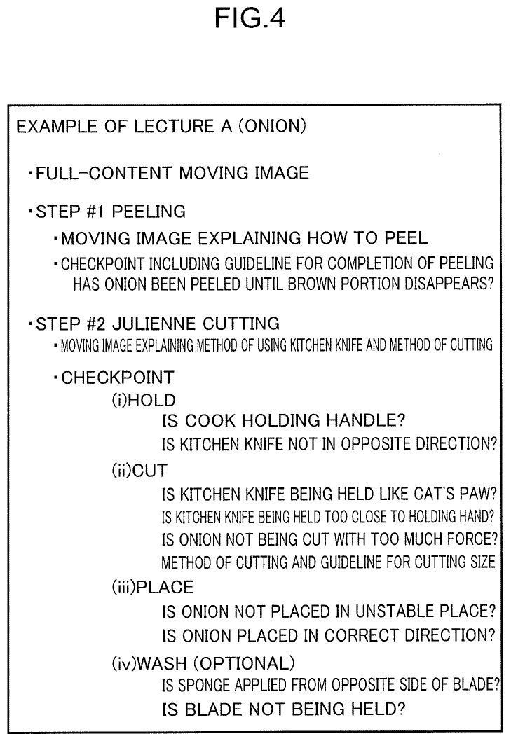

FIG. 4 is a diagram showing detailed contents of the lecture A shown in FIG. 3. The lecture A includes a full-content moving image, and a moving image and checkpoint for each of a plurality of steps. The full-content moving image is a moving image showing an overview of the cooking content from the start of cooking to the end of cooking. The moving image for each step is a moving image showing the cooking content at the corresponding step in more detail than the full-content moving image. The full-content moving image and the moving image for each step are one example of the cooking content, and the checkpoint is one example of the instruction content.

The lecture A includes peeling (step #1) and julienne cutting (step #2). The moving image for the peeling step is a moving image explaining how to peel an onion, for example, a moving image that features a zoomed-in scene of a model person peeling an onion with a kitchen knife. The checkpoint for peeling indicates a guideline for the completion of the peeling, for example, “Has the onion been peeled until the brown portion disappears?”. Therefore, the instructor who refers to the lecture information can give appropriate verbal instruction to the cook near the end of the peeling step, such as “Peel the onion until the brown portion disappears”.

The moving image for the julienne cutting step is a moving image explaining julienne cutting of an onion, for example, a moving image explaining the method of using a kitchen knife and the method of cutting.

The checkpoint for the julienne cutting step includes the checkpoint for (i) holding, (ii) cutting, (iii) placing, and (iv) washing. (i) The checkpoint for holding includes, for example, whether the cook is holding the handle of the kitchen knife, or whether the kitchen knife is not in the opposite direction. (ii) The checkpoint for cutting includes, for example, whether the kitchen knife is being held like a cat's paw, whether the kitchen knife is being held too close to the hand holding an onion, whether an onion is being cut with too much force, points on the method of cutting, and guidelines for the cutting size. (iii) The checkpoint for placing includes whether an onion is not placed in an unstable place and whether an onion is placed in the correct direction. (iv) The checkpoint for washing includes whether a sponge is being applied from the opposite side of the blade, and whether the blade is not being held. Note that the (iv) checkpoint is optional and may be omitted.

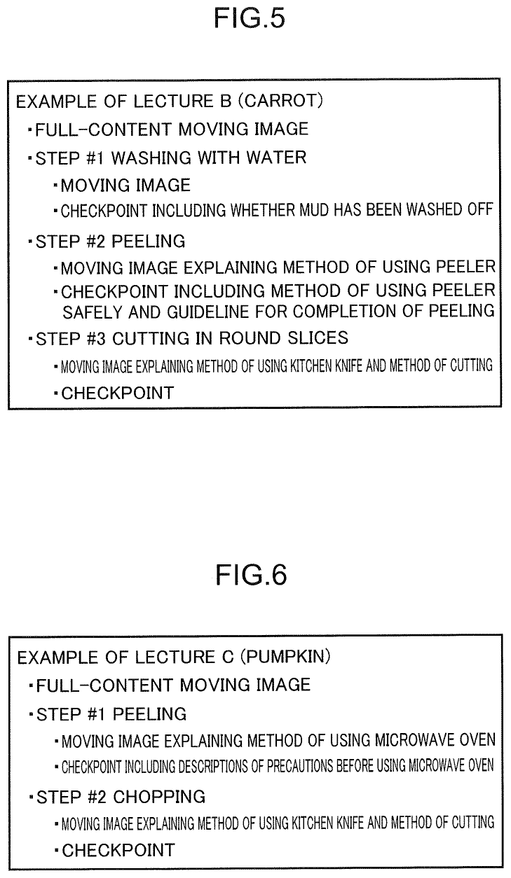

FIG. 5 is a diagram showing detailed contents of the lecture B shown in FIG. 3. The lecture B includes the full-content moving image, and the moving image and the checkpoint for each of a plurality of steps, in a similar manner to the lecture A. The plurality of steps includes washing with water (step #1), peeling (step #2), and cutting into round slices (step #3). For example, the checkpoint for washing with water includes whether mud on a carrot has been washed off. For example, the moving image for peeling includes a moving image explaining the method of using the peeler. The checkpoint for peeling includes the method of using the peeler safely and guidelines for the completion of peeling. For example, the moving image for cutting into round slices includes the method of using a kitchen knife and the method of cutting.

FIG. 6 is a diagram showing detailed contents of the lecture C shown in FIG. 3. The lecture C includes the full-content moving image, and the moving image and the checkpoint for each of a plurality of steps, in a similar manner to the lecture A. The plurality of steps includes peeling (step #1) and chopping (step #2). For example, the moving image for peeling includes a moving image explaining the method of using a microwave oven. For example, the checkpoint for peeling includes descriptions of precautions before using a microwave oven. For example, the moving image for the chopping step includes a moving image explaining the method of using a kitchen knife and a moving image explaining the method of cutting.

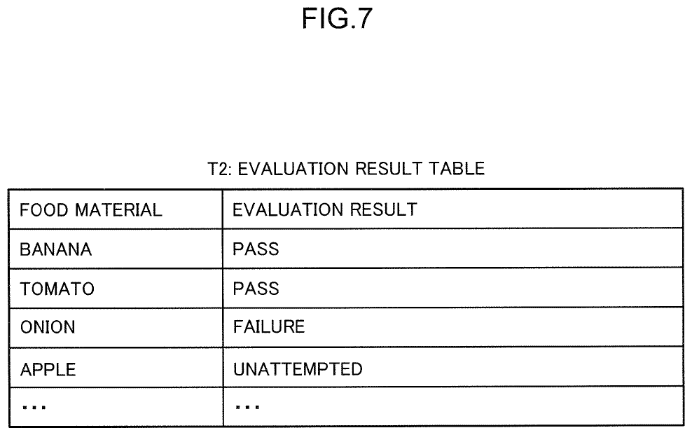

The reference is made back to FIG. 2. The evaluation result storage unit 132 stores an evaluation result table T2 (FIG. 7). FIG. 7 is a diagram showing data structure of the evaluation result table T2 of a first example of the present embodiment. The evaluation result table T2 records evaluation results of a certain cook by the instructor for each cooking content. Here, food materials are adopted as the cooking content. In the evaluation result table T2, the food material with the evaluation result “pass” is a food material for which the evaluation result by the instructor is a pass, the food material with the evaluation result “failure” is a food material for which the cook has attempted in the past but the evaluation result by the instructor is a failure, and the food material with the evaluation result “unattempted” is a food material for which the cook has not attempted cooking. In this example, the evaluation result of the cook is a pass for banana and tomato, but is a failure for onion. Meanwhile, in this example, apple is unattempted. This evaluation result may be an evaluation result of the food material the instructor has actually provided instruction, or may be an evaluation result of the food material for which the instructor has not actually provided instruction but for which it is presumed to be a pass by comparison with the past evaluation result. Meanwhile, the unattempted food material may be recorded or not recorded. This evaluation is input by the instructor through the user terminal 2.

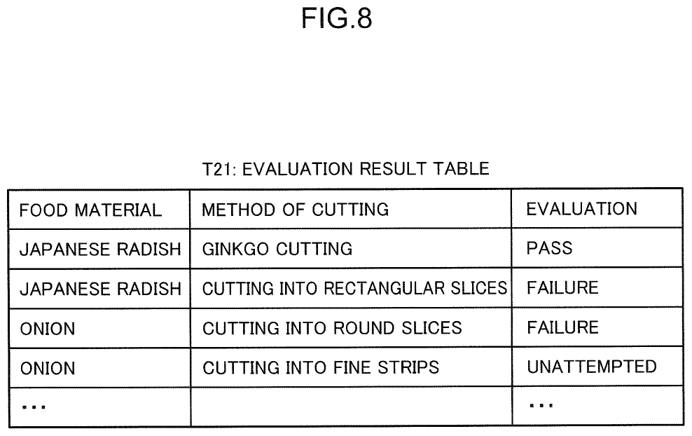

The present embodiment may adopt an evaluation result table T21 shown in FIG. 8 instead of the evaluation result table T2. FIG. 8 is a diagram showing data structure of the evaluation result table T21 of a second example of the present embodiment. The evaluation result table T21 has a column for the method of cutting (processing method) in addition to the evaluation result table T2. That is, the evaluation result table T21 includes the food material and the method of cutting as the cooking content, and records the evaluation of the food material and the method of cutting by the instructor. In the example of FIG. 8, the evaluation of cutting a Japanese radish into ginkgo is a pass, but the evaluation of cutting a Japanese radish into rectangular slices is a failure. Meanwhile, in the example of FIG. 8, the evaluation of cutting an onion into round slices is a failure, and cutting an onion into pieces is unattempted. The unattempted food material and the method of cutting may be recorded or not recorded. In this way, the evaluation result table T21, which records the evaluation result of the food material and the method of cutting by the instructor, can record the evaluation result of the cook in more detail.

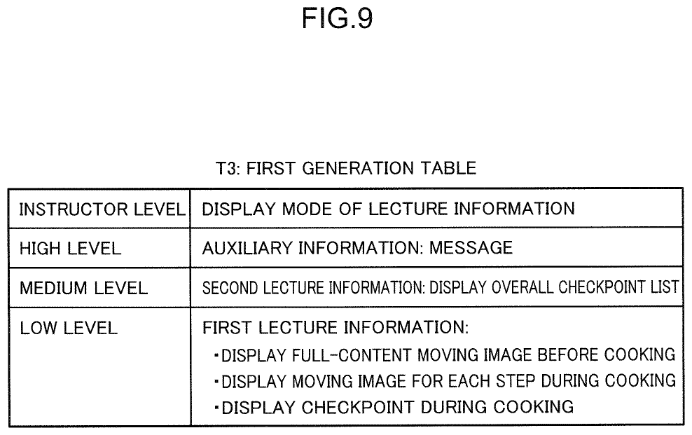

The reference is made back to FIG. 2. The first generation table storage unit 133 stores a first generation table T3. FIG. 9 is a diagram showing one example of data structure of the first generation table T3. The first generation table T3 is a table that defines the display mode of the lecture information according to the instruction level, and is referenced by the generation unit 122 when generating the lecture information.

When the instruction level is the low level, the first lecture information is displayed in the display terminal 3. The first lecture information includes a full-content moving image (cooking content), a moving image for each step (cooking content), and a checkpoint (instruction content). Note that the first generation table T3 also defines display timing of the lecture information. For example, the first generation table T3 defines the display timing in the first lecture information, such as the full-content moving image is displayed before cooking, the moving image for each step is displayed during cooking, and the checkpoint is displayed during cooking. In this case, the instructor and the cook can play back the full-content moving image to check the content of the cooking that will be executed. After that, the instructor and the cook can refer to the moving image and the checkpoint for each step to check the cooking content in detail for each step. This allows the instructor to provide fine-grained instruction for each step.

When the instruction level is the medium level, the second lecture information is displayed in the display terminal 3. The second lecture information includes a checkpoint list that lists the checkpoints (instruction content), but does not include the full-content moving image and the moving image for each step. In this case, the instructor can provide appropriate instruction by referring as appropriate to the checkpoint list displayed on the display of the display terminal 3 while the cook is cooking.

When the instruction level is the high level, the auxiliary information that includes none of the full-content moving image, the moving image for each step, and the checkpoint is generated. The auxiliary information includes, for example, a message urging the instructor to start instruction. The instructor for whom the auxiliary information is displayed provides the cook with instruction on the method of cooking directly without relying on the lecture information. In this way, as the instruction level becomes lower, the amount of information contained in the lecture information increases, allowing the instructor to provide appropriate instruction according to the instruction level of the instructor.

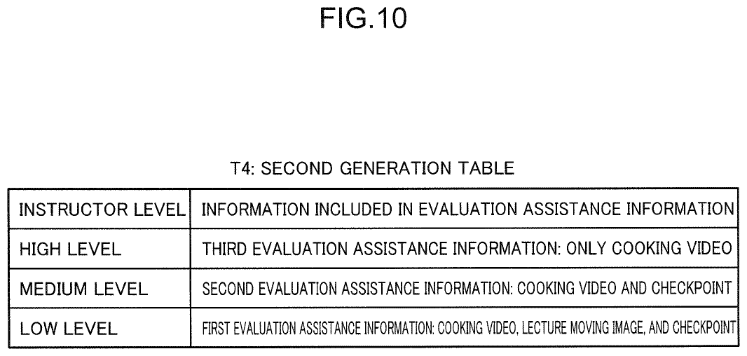

The reference is made back to FIG. 2. The second generation table storage unit 134 stores a second generation table T4. FIG. 10 is a diagram showing one example of data structure of the second generation table T4. The second generation table T4 is a table that defines information included in the evaluation assistance information according to the instruction level, and is referred to by the generation unit 122 when generating the evaluation assistance information.

When the instruction level is the low level, the first evaluation assistance information including the cooking video (execution information), a lecture moving image (cooking content), and the checkpoint (instruction content) is generated. The lecture moving image is a moving image used by the instructor when providing instruction, specifically, the full-content moving image and the moving image for each step shown in FIG. 9.

When the instruction level is the medium level, the second evaluation assistance information including the cooking video (execution information) and the checkpoint (instruction content) is generated.

When the instruction level is the high level, third evaluation assistance information including only the cooking video (execution information) is generated.

In this way, as the instruction level of the instructor becomes lower, the amount of information contained in the evaluation assistance information increases, allowing the instructor to make an appropriate evaluation of the cook according to the instruction level of the instructor.

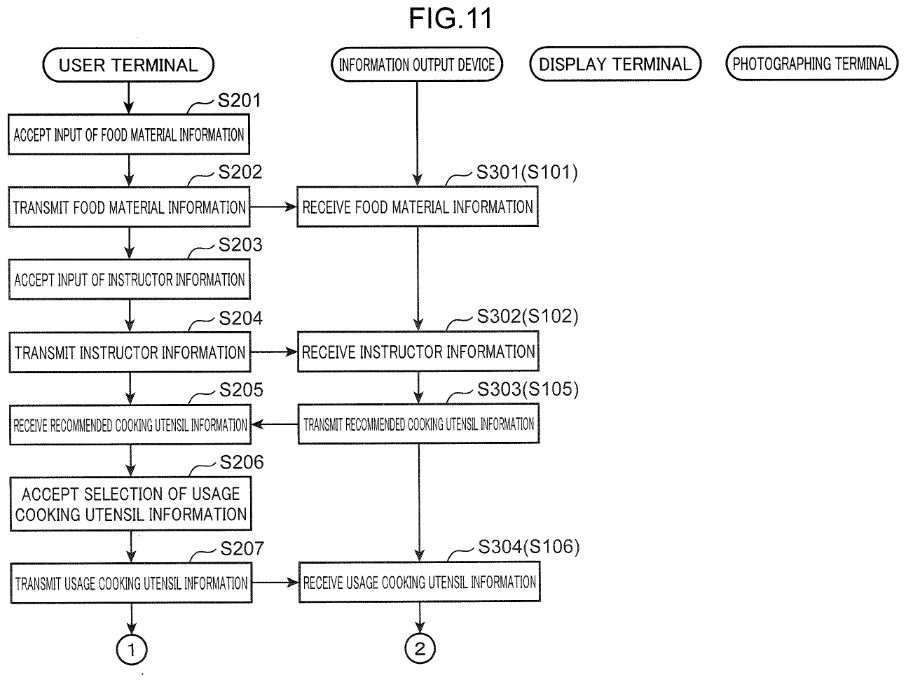

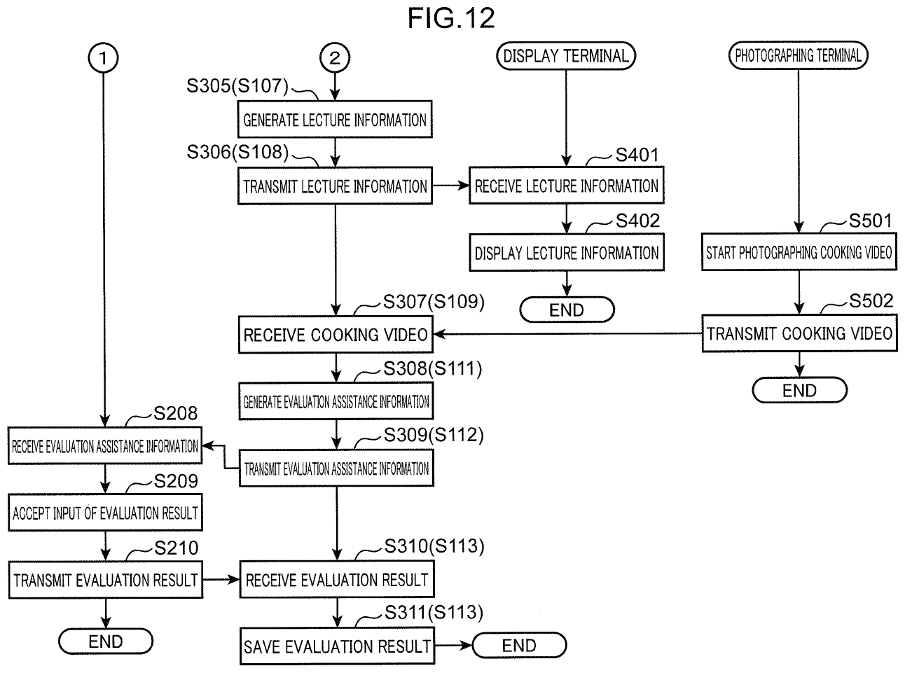

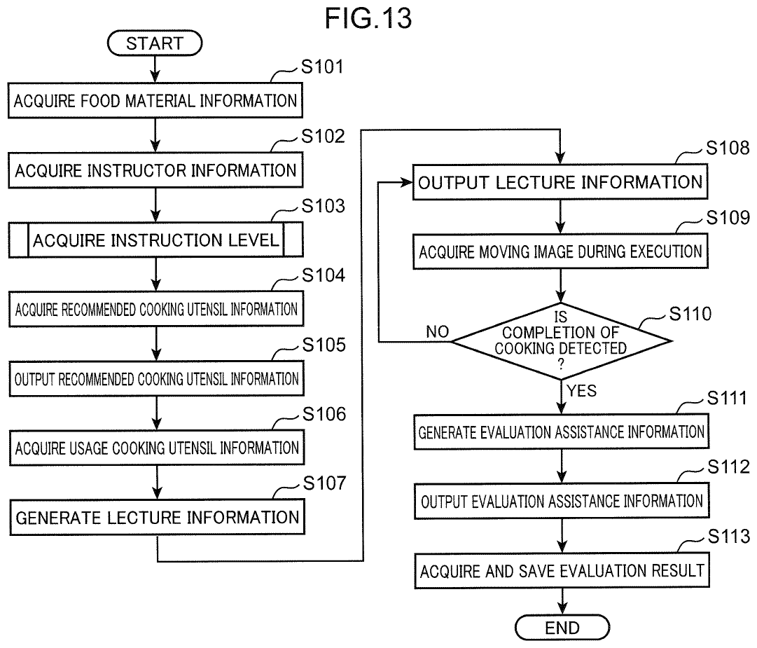

The configuration of the information output device 1 has been described above. Subsequently, the processing of the information output system 100 will be described. FIG. 11 is a flowchart showing one example of the processing of the information output system 100 shown in FIG. 1. FIG. 12 is a flowchart following FIG. 11. Note that in FIGS. 11 and 12, the step number in parentheses corresponds to the step number in FIG. 13, which will be described later.

### (Step S201)

The user terminal 2 accepts input of the food material information from the user. The food material information may be input by the instructor or the cook.

### (Step S202)

The user terminal 2 transmits the food material information accepted in step S201 to the information output device 1.

### (Step S301)

The information output device 1 receives the food material information transmitted from the user terminal 2.

### (Step S203)

The user terminal 2 accepts input of the instructor information from the instructor. The instructor information includes the experience information and the comprehension level of the instruction content, as described above.

### (Step S204)

The user terminal 2 transmits the instructor information accepted in step S203 to the information output device 1.

### (Step S302)

The information output device 1 receives the instructor information transmitted from the user terminal 2. The information output device 1 generates the instruction level based on the received instructor information.

### (Step S303)

The information output device 1 that has received the instructor information transmits recommended cooking utensil information to recommend the cooking utensil used for cooking the food material indicated by the food material information acquired in step S301 to the cook.

### (Step S205)

The user terminal 2 receives the recommended cooking utensil information transmitted from the information output device 1. The received recommended cooking utensil information is displayed on the display of the user terminal 2.

### (Step S206)

The user terminal 2 accepts selection of usage cooking utensil information indicating the cooking utensil to use from the cook who refers to the recommended cooking utensil information.

### (Step S207)

The user terminal 2 transmits the usage cooking utensil information to the information output device 1.

### (Step S304)

The information output device 1 receives the usage cooking utensil information transmitted from the user terminal 2.

### (Step S305)

The information output device 1 generates the lecture information based on the instruction level.

### (Step S306)

The information output device 1 transmits the generated lecture information to the display terminal 3.

### (Step S401)

The display terminal 3 receives the lecture information transmitted from the information output device 1.

### (Step S402)

The display terminal 3 displays the received lecture information on the display.

### (Step S501)

When the lecture information is displayed, the photographing terminal 4 starts photographing the cooking video. Here, the cooking video is photographed at a predetermined frame rate.

### (Step S502)

The photographing terminal 4 transmits the cooking video to the information output device 1. The cooking video may be transmitted constantly during photographing (during cooking), or may be transmitted after photographing (after cooking).

### (Step S307)

The information output device 1 receives the cooking video transmitted from the photographing terminal 4.

### (Step S308)

The information output device 1 generates the evaluation assistance information based on the instruction level.

### (Step S309)

The information output device 1 transmits the evaluation assistance information to the user terminal 2.

### (Step S208)

The user terminal 2 receives the evaluation assistance information transmitted from the information output device 1. The evaluation assistance information is displayed on the display of the user terminal 2.

### (Step S209)

The user terminal 2 accepts input of the evaluation result from the instructor who refers to the evaluation assistance information.

### (Step S210)

The user terminal 2 transmits the accepted evaluation result to the information output device 1.

### (Step S310)

The information output device 1 receives the evaluation result transmitted from the user terminal 2.

### (Step S311)

The information output device 1 registers the received evaluation result with the evaluation result table T2.

The overview of the processing of the information output system 100 has been described above. Subsequently, the processing of the information output device 1 will be described. FIG. 13 is a flowchart showing one example of the processing of the information output device 1.

### (Step S101)

The acquisition unit 121 acquires the food material information transmitted from the user terminal 2 by using the communication unit 11. Here, the food material information to be transmitted includes food materials other than the food material of which the evaluation result “pass” is obtained in the evaluation result table T2. That is, the food material information to be transmitted includes a failed food material that the cook has attempted in the past but has become a failure, and an unattempted food material that has not been attempted in the past.

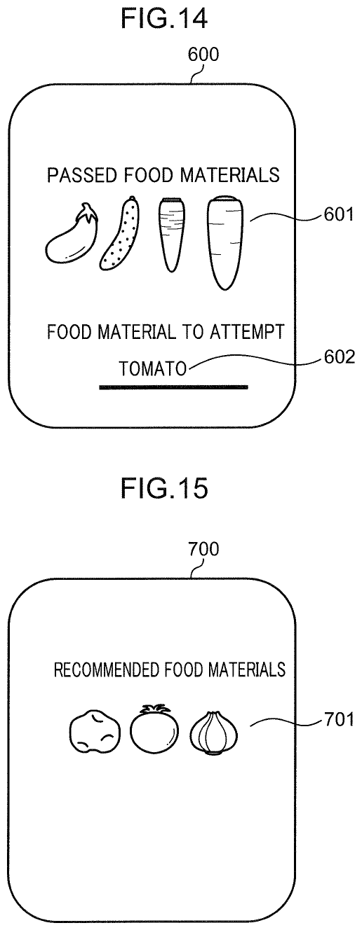

FIG. 14 is a diagram showing a food material determination screen 600 of the first example of the present embodiment. The food material determination screen 600 is displayed in the user terminal 2 when determining the food material information. The food material determination screen 600 includes a passed food material display column 601 that displays passed food materials, and a food material input column 602 for inputting a cooking food material for which cooking is attempted.

The passed food material display column 601 displays the passed food materials for which the cook has passed in the past. Here, eggplant, cucumber, carrot, and Japanese radish are displayed as the passed food materials.

The food material input column 602 is a column for inputting the food material the cook wants to attempt. When the user taps the food material input column 602, recommended food materials that are recommended for cooking to the cook are displayed in sequence. The user can switch the display of the recommended food materials by swiping the food material input column 602. The user displays the desired recommended food material in the food material input column 602. When the user taps the food material input column 602, the recommended food material is determined as the cooking food material. Note that the input operation of the cooking food material may be executed by the cook or the instructor.

The acquisition unit 121 may, for example, determine the display order of the recommended food materials based on the difficulty level of the passed food materials. In this case, the difficulty level of each food material is registered in advance with the evaluation result table T2. The acquisition unit 121 may rank unattempted or failed food materials in order of the difficulty level close to the food material with the highest difficulty level among the passed food materials registered with the evaluation result table T2, and display the recommended food materials in the food material input column 602 according to the ranking.

FIG. 15 is a diagram showing a food material determination screen 700 of the second example of the present embodiment. The food material determination screen 700 includes a recommended food material display column 701. The recommended food material display column 701 displays a list of the recommended food materials. The recommended food materials displayed in the recommended food material display column 701 are the failed food materials and the unattempted food materials. As the display order of the recommended food materials displayed in the recommended food material display column 701, for example, the order determined based on the difficulty level of the passed food materials described above may be adopted. The cook may select the cooking food material by tapping an image for which cooking is desired among images of the recommended food materials displayed in the recommended food material display column 701. For example, the cook may determine the food material of interest among the recommended food materials displayed in the recommended food material display column 701 as the cooking food material, or may determine the food material in a refrigerator among the recommended food materials displayed in the recommended food material display column 701 as the cooking food material.

The acquisition unit 121 may allow the cook to select the method of cutting the food material by separately displaying a selection screen to select the method of cutting the food material on the display of the user terminal 2. For example, when the cooking food material is determined in the food material determination screen 600 or 700, the acquisition unit 121 may display a selection screen that lists predetermined methods of cutting the food material for the determined cooking food material to the user terminal 2, and determine the method of cutting the food material by causing the user to input an operation to select the target method of cutting the food material from among predetermined methods of cutting the food material. Examples of the predetermined methods of cutting the food material are ginkgo cutting, cutting into rectangular slices, cutting into pieces, cutting into fine strips, and the like.

### (Step S102)

The acquisition unit 121 acquires the instructor information transmitted from the user terminal 2 by using the communication unit 11. The instructor information is input by the instructor using the user terminal 2. The instructor information to be input includes the experience information indicating whether the instructor has the execution experience in the cooking food material, and the comprehension level of the instruction content. Therefore, the instructor inputs the experience information and the comprehension level of the instruction content into the user terminal 2.

The acquisition unit 121 only needs to acquire the experience information and the comprehension level of the instruction content, by displaying an input screen of the experience information and the comprehension level of the instruction content on the display of the user terminal 2, and causing the instructor to input the experience information and the comprehension level of the instruction content.

For example, when the cooking food material is a tomato, the acquisition unit 121 may acquire the experience information by displaying a message such as “Have you ever cut a tomato?” on the display of the user terminal 2, and causing the instructor to input whether the instructor has the execution experience. Note that if the experience information about the cooking food material is managed by an external system connected to the network, the acquisition unit 121 may acquire the experience information by accessing the external system. The external system is, for example, a cooking assistance system that provides the user with cooking assistance.

For example, the acquisition unit 121 displays a list of a plurality of checkpoints corresponding to the cooking food material on the display of the user terminal 2, and causes the instructor to input whether the instructor understands each checkpoint. Then, the acquisition unit 121 may determine, as the comprehension level, the proportion of the number of checkpoint items into which input of understandable is made to the total number of checkpoint items.

Alternatively, the acquisition unit 121 may determine the comprehension level based on the past instruction situation of the instructor. For example, when the instructor has provided cooking instruction in a certain food material in the past, the acquisition unit 121 may determine the comprehension level of the instructor based on whether the instructor gives appropriate verbal instruction to the cook at a predetermined checkpoint. In this case, the memory 13 only needs to store instruction history information on the instructor. The instruction history information includes, for example, one or more instruction history records. Each instruction history record stores an identifier of the instructor, the food material information for which instruction is provided, the instruction date and time, and the comprehension level in association with one another. The comprehension level is, for example, the proportion of the number of checkpoint items at which the instructor has been able to give appropriate verbal instruction to the total number of checkpoint items. When the instruction history information includes a plurality of instruction history records, the comprehension level of the instructor is, for example, an average value of the comprehension level of the instruction history records.

Alternatively, the acquisition unit 121 may determine the comprehension level by feeding back the cook's evaluation value of the instructor's past instruction (instruction evaluation value). In this case, the memory 13 may store the evaluation feedback history. The evaluation feedback history includes, for example, one or more evaluation feedback records, and each evaluation feedback record stores the identifier of the instructor, the identifier of the cook, the food material information for which instruction is provided, the instruction date and time, and the instruction evaluation value in association with one another. The instruction evaluation value has, for example, a value of a predetermined level (for example, 5 levels). The comprehension level of the instructor is, for example, an average value of the instruction evaluation values of the evaluation feedback records.

### (Step S103)

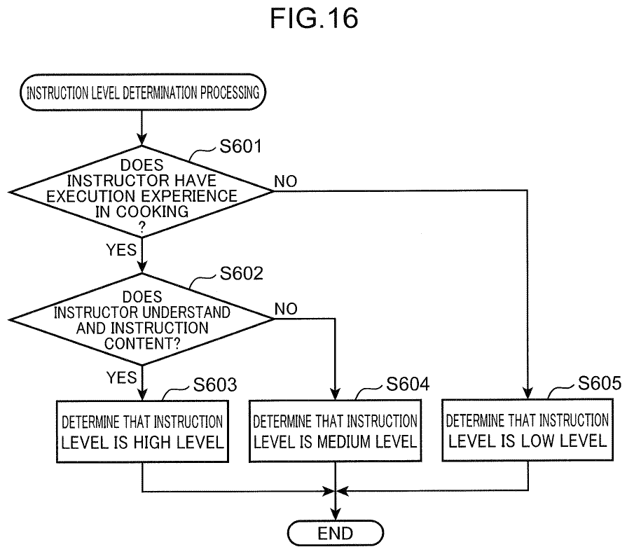

The acquisition unit 121 acquires the instruction level of the instructor based on the experience information and the comprehension level acquired in step S102. FIG. 16 is a flowchart showing details of instruction level determination processing.

### (Step S601)

The acquisition unit 121 determines whether the instructor has the execution experience in cooking the cooking food material. Here, the acquisition unit 121 determines that the instructor has the execution experience when the experience information acquired in step S102 shows that the instructor has the execution experience, and determines that the instructor does not have the execution experience when the experience information acquired in step S102 shows that the instructor does not have the execution experience. When it is determined that the instructor has the execution experience (YES in step S601), the process proceeds to step S602, and when it is determined that the instructor does not have the execution experience (NO in step S602), the process proceeds to step S605.

### (Step S602)

The acquisition unit 121 determines whether the instructor understands the instruction content. Here, the acquisition unit 121 determines that the instructor understands the instruction content when the comprehension level acquired in step S102 is larger than a predetermined value, and determines that the instructor does not understand the instruction content when the comprehension level acquired in step S102 is equal to or less than the predetermined value. When it is determined that the instructor understands the instruction content (YES in step S602), the process proceeds to step S603, and when it is determined that the instructor does not understand the instruction content (NO in step S602), the process proceeds to step S604.

### (Step S603)

The acquisition unit 121 determines that the instruction level is the high level because the instructor has the execution experience in cooking and understands the instruction content.

### (Step S604)

The acquisition unit 121 determines that the instruction level is the medium level because the instructor has the execution experience in cooking but does not understand the instruction content.

### (Step S605)

The acquisition unit 121 determines that the instruction level is the low level because the instructor does not have the execution experience in cooking and does not understand the instruction content. The instruction level of the instructor is determined as described above. The reference is made back to FIG. 13.

### (Step S104)

The acquisition unit 121 determines the recommended cooking utensil that is one or more cooking utensils predetermined for the cooking food material, and acquires the recommended cooking utensil information indicating the determined recommended cooking utensil from the memory 13. For example, the acquisition unit 121 may determine the recommended cooking utensil by referring to the lecture information table T1 (FIG. 3). For example, when the cooking food material is carrot, a kitchen knife and a peeler are determined as the recommended cooking utensil.

### (Step S105)

The acquisition unit 121 outputs the recommended cooking utensil information to the user terminal 2 by using the communication unit 11.

### (Step S106)

The acquisition unit 121 acquires, from the user terminal 2, the usage cooking utensil information indicating the cooking utensil selected by the user (usage cooking utensil) from among the recommended cooking utensils indicated by the recommended cooking utensil information.

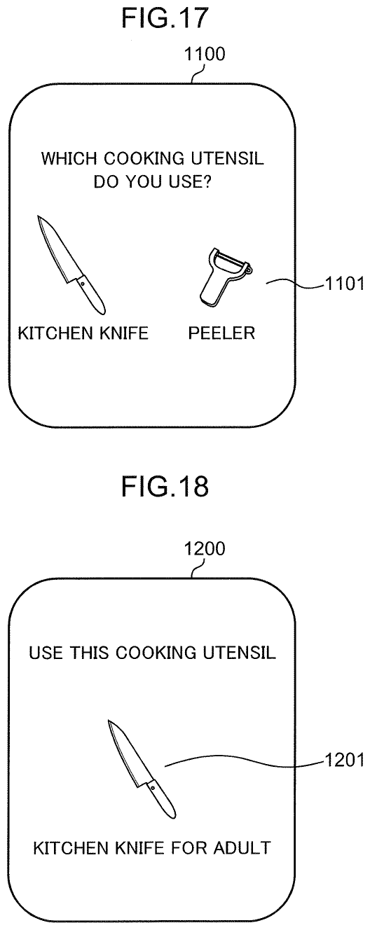

FIG. 17 is a diagram showing a cooking utensil selection screen 1100 according to the first example of the present embodiment. The cooking utensil selection screen 1100 includes a recommended cooking utensil display column 1101. The recommended cooking utensil display column 1101 displays one or more recommended cooking utensils included in the recommended cooking utensil information. Here, the recommended cooking utensil display column 1101 displays a kitchen knife and a peeler. This is because the kitchen knife and the peeler are stored in the lecture information table Ti as the cooking utensil corresponding to the cooking food material.

FIG. 18 is a diagram showing a cooking utensil selection screen 1200 according to the second example of the present embodiment. The cooking utensil selection screen 1200 includes a recommended cooking utensil display column 1201. Here, a kitchen knife for adult is displayed in the recommended cooking utensil display column 1201. This is because the kitchen knife for adult is stored in the lecture information table T1 as the cooking utensil corresponding to the cooking food material.

The user selects the usage cooking utensil by tapping an image of the cooking utensil to use for the cooking this time from among the recommended cooking utensils displayed in the recommended cooking utensil display column 1101 or 1201. The user terminal 2 outputs the usage cooking utensil information indicating the usage cooking utensil selected by the user to the information output device 1. This allows the acquisition unit 121 to acquire the usage cooking utensil information.

### (Step S107)

The generation unit 122 generates the lecture information based on the instruction level. For example, the generation unit 122 refers to the first generation table T3 and generates the lecture information according to the display form of the lecture information corresponding to the instruction level. When the instruction level is the high level, the auxiliary information is generated. When the instruction level is the medium level, the second lecture information is generated. When the instruction level is the low level, the first lecture information is generated.

### (Step S108)

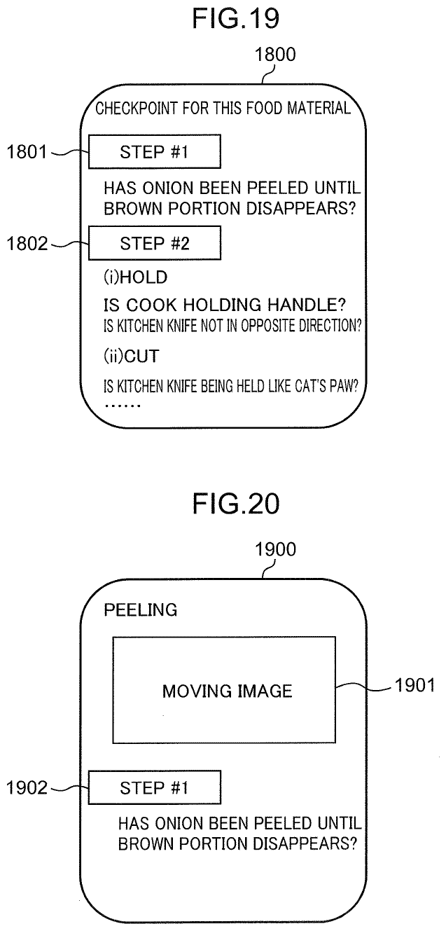

The output unit 123 outputs the lecture information generated in step S107 to the display terminal 3 by using the communication unit 11. FIG. 19 is a diagram showing a display screen 1800 of the second lecture information. The display screen 1800, which is displayed to the instructor of the medium instruction level, displays the checkpoint list. Specifically, the display screen 1800 displays a plurality of checkpoints step by step. The display screen 1800 corresponds to the lecture A (onion) shown in FIG. 4.

The display screen 1800 includes a checkpoint display column 1801 that displays the checkpoint of step #1 and a checkpoint display column 1802 that displays the checkpoint of step #2. The checkpoint of step #1 shown in the lecture A (FIG. 4) “Has the onion been peeled until the brown portion disappears?” is displayed. The checkpoint display column 1802 displays the checkpoint “(i) Hold: Is the handle held? . . . ” of step #2 shown in the lecture A (FIG. 4).

FIG. 20 is a diagram showing a display screen 1900 of the first lecture information. The display screen 1900, which is displayed to the instructor of the low instruction level, includes a moving image display column 1901 and a checkpoint display column 1902. In this example, the display screen 1900 corresponds to the lecture A (onion) shown in FIG. 4. The moving image display column 1901 displays the full-content moving image and the moving image for each step. Upon detecting the start of cooking, the output unit 123 first displays the full-content moving image in the moving image display column 1901. The output unit 123 may, for example, detect the start of cooking based on the video photographed by the photographing terminal 4, or may detect the start of cooking based on a cooking start instruction input by the user to the display terminal 3.

When the display of the full-content moving image is completed, next, the output unit 123 displays the moving image of step #1 in the moving image display column 1901. Upon detecting the completion of cooking by the cook in step #1, next, the output unit 123 displays the moving image of step #2 in the moving image display column 1901. In this way, the output unit 123 displays the moving image of each step in the moving image display column 1901 in synchronization with the cooking the cook is executing. Here, the output unit 123 may detect the completion of cooking of each step by the cook by executing image processing on the video photographed by the photographing terminal 4, or may detect the completion of each step based on a step completion instruction input by the user to the display terminal 3. For example, when the state of the food material included in the video reaches a predetermined state indicating the completion of step, the output unit 123 may determine that the step has completed. The predetermined state indicating the completion of step is, for example, in step #1 of the lecture A, the state where the brown portion (skin) of onion disappears.

The checkpoint display column 1902 displays the checkpoint. For example, upon detecting that the predetermined checkpoint display timing for each of the plurality of checkpoints has arrived, the output unit 123 displays the checkpoint in the checkpoint display column 1902. For example, in step #1 of the lecture A, when the proportion of the brown portion in the whole onion becomes equal to or less than a threshold, the checkpoint “Has the onion been peeled until the brown portion disappears?”' is displayed in the checkpoint display column 1902. This allows the instructor to give appropriate verbal instruction to the cook with appropriate timing.

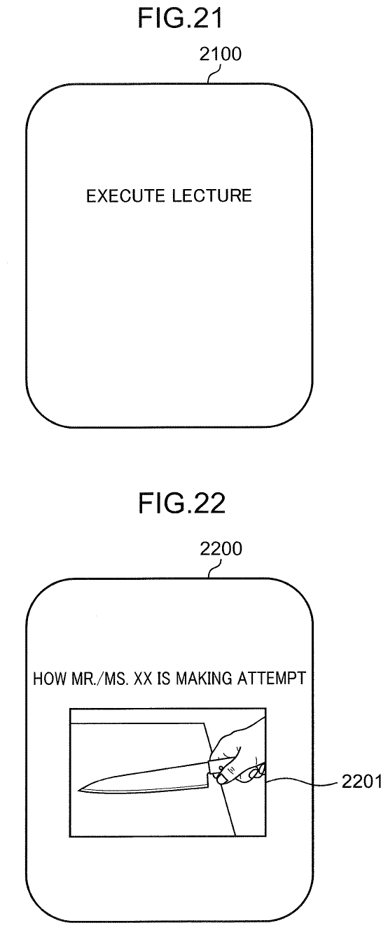

FIG. 21 is a diagram showing a display screen 2100 of the auxiliary information. The display screen 2100 is displayed to the instructor of the high instruction level, displays, for example, a message urging the instructor to start instruction such as “Execute lecture”, but does not display the checkpoint, the full-content moving image, and the moving image for each step.

### (Step S109)

The acquisition unit 121 acquires the cooking video photographed by the photographing terminal 4. The acquisition unit 121 acquires the cooking video in parallel with the display of the lecture information in step S108. The acquired cooking video is stored in the memory 13. This allows the instructor to watch the cooking video after the cooking is completed, and to check dangerous work that has not been noticed during the instruction and/or work of the cook that has been actually done.

### (Step S110)

The output unit 123 detects whether the cook has completed cooking. For example, when the state of the food material included in the cooking video reaches a predetermined state indicating the completion of the final step of the cooking content, the output unit 123 only has to determine that the cooking has been completed. The completion of cooking may be detected by input from the user. When the completion of cooking is detected (YES in step S110), the process proceeds to step S111, and when the completion of cooking is not detected (NO in step S110), the process returns to step S108.

### (Step S111)

The generation unit 122 generates the evaluation assistance information based on the instruction level. For example, the generation unit 122 generates the evaluation assistance information corresponding to the instruction level according to the second generation table T4 (FIG. 10). That is, when the instruction level is the low level, the first evaluation assistance information is generated; when the instruction level is the medium level, the second evaluation assistance information is generated; and when the instruction level is the high level, the third evaluation assistance information is generated.

### (Step S112)

The output unit 123 outputs the evaluation assistance information generated in step S111 to the user terminal 2 by using the communication unit 11. As a result, the first evaluation assistance information, the second evaluation assistance information, or the third evaluation assistance information is displayed in the user terminal 2.

FIG. 22 is a diagram showing a display screen 2200 of the third evaluation assistance information. The display screen 2200 includes a cooking video display column 2201 that displays the cooking video. In the upper part of the cooking video display column 2201, a message saying “How Mr./Ms XX is making an attempt” is displayed, showing that the cooking video of the cook “Mr./Ms XX” is displayed in the cooking video display column 2201. The display screen 2200, which is displayed to the instructor of the high instruction level, includes only the cooking video.

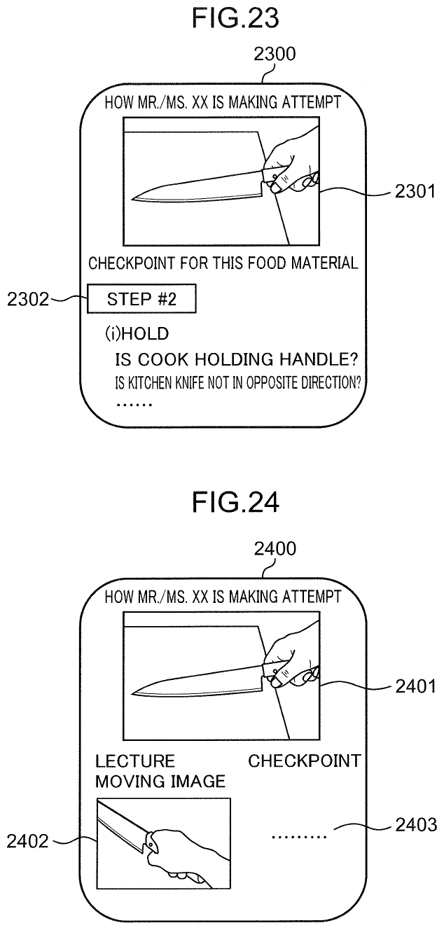

FIG. 23 is a diagram showing a display screen 2300 of the second evaluation assistance information. The display screen 2300 includes a cooking video display column 2301 and a checkpoint display column 2302. The cooking video display column 2301 displays the cooking video of the cook. The checkpoint display column 2302 displays the checkpoint. The output unit 123 displays the checkpoint corresponding to the step of the cooking video displayed in the cooking video display column 2301 in the checkpoint display column 2302. In this example, since the cooking video of the step of holding a kitchen knife is displayed in the cooking video display column 2301, the checkpoint corresponding to the step of holding a kitchen knife is displayed in the checkpoint display column 2302. The display screen 2300, which is displayed to the instructor of the medium instruction level, displays the cooking video and the checkpoint, but does not display the lecture moving image.

FIG. 24 is a diagram showing a display screen 2400 of a first example of the first evaluation assistance information. The display screen 2400 includes a cooking video display column 2401, a lecture moving image display column 2402, and a checkpoint display column 2403. The cooking video display column 2401 and the checkpoint display column 2403 are the same as the cooking video display column 2301 and the checkpoint display column 2302 of FIG. 23. The lecture moving image display column 2402 displays the lecture moving image. The output unit 123 displays the checkpoint corresponding to the step of the cooking video displayed in the cooking video display column 2401 in the checkpoint display column 2403. Furthermore, the output unit 123 displays the lecture moving image corresponding to the step of the cooking video displayed in the cooking video display column 2401 in the lecture moving image display column 2402. In this example, since the cooking video of the step of holding a kitchen knife is displayed in the cooking video display column 2401, the lecture moving image corresponding to the step of holding a kitchen knife is displayed. Since the display screen 2400 is displayed to the instructor of the low instruction level, the cooking video, the lecture moving image, and the checkpoint are displayed. This allows the instructor of the low instruction level to evaluate the cooking of the cook while comparing the lecture moving image, the checkpoint, and the cooking video.

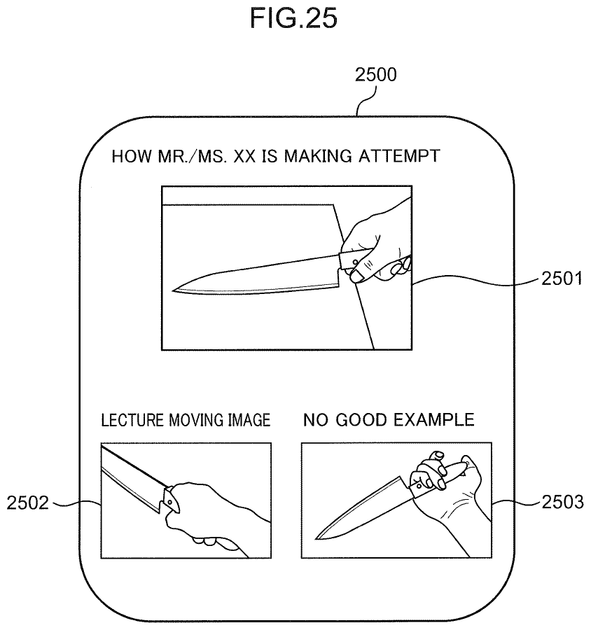

FIG. 25 is a diagram showing a display screen 2500 of a second example of the first evaluation assistance information. The display screen 2500 includes a cooking video display column 2501, a lecture moving image display column 2502, and a checkpoint display column 2503. The cooking video display column 2501 and the lecture moving image display column 2502 are the same as the cooking video display column 2401 and the lecture moving image display column 2402 of FIG. 24. The checkpoint display column 2503 displays, as a checkpoint, an image of a no good image example showing an action that should be determined to be a failure. Here, since the cooking video of the step of holding a kitchen knife is displayed in the cooking video display column 2501, a moving image showing a no good example of the method of holding a kitchen knife is displayed in the checkpoint display column 2503. Therefore, the instructor can determine a failure if the cook's method of holding a kitchen knife in the cooking video is similar to the method of holding a kitchen knife shown in the no good example displayed in the checkpoint display column 2503.

### (Step S113)

The acquisition unit 121 acquires the instructor's evaluation result of the cook transmitted by the instructor from the user terminal 2 by using the communication unit 11, and stores the acquired evaluation result in the evaluation result table T2. As a result, the evaluation result is stored in the evaluation result table T2 in association with the cooked food material. The cook refers to the evaluation assistance information to determine whether the cook is appropriately cooking the food material. When it is determined that the cook is cooking appropriately, the cook inputs the evaluation result of pass into the user terminal 2, and when it is determined that the cook is not cooking appropriately, the cook inputs the evaluation result of failure into the user terminal 2. The failure is one example of an unachieved evaluation.

Note that the instructor may input the evaluation result for each step. For example, since the lecture A (FIG. 4) includes step #1 of peeling and step #2 of julienne cutting, the instructor may input the evaluation result of pass and failure for each step. In this case, the evaluation result of each food material is recorded for each step in the evaluation result table T2 (FIG. 7). In the present embodiment, it may be determined that, when all steps for a certain food material pass, the food material passes. Therefore, the food material with some steps being a failure is displayed as the recommended food material in the food material determination screen 600 or 700.

In this way, the present embodiment, which can generate the lecture information according to the instruction level of the instructor, can cause the instructor to provide the cook with appropriate cooking instruction.

Furthermore, in the present embodiment, since the evaluation assistance information according to the instruction level is generated, the instructor can smoothly evaluate the cook.

Modifications described below can be adopted in the present disclosure.

(1) The cooking video included in the evaluation assistance information may be an appropriately edited video. For example, the edited video is a video obtained by cutting a frame corresponding to the checkpoint from the cooking video. The edited video is, for example, a video obtained by cutting a frame corresponding to the lecture moving image from the cooking video. When the cooking video includes a frame of washing the food material and a frame of placing the food material on a cutting board but the lecture moving image starts with the step of cutting the food material, in the edited video, the video in which the frame of washing the food material and the frame of placing the food material on a cutting board are edited is omitted.

(2) When the instructor inputs timing when the instructor wants to look back during instruction, the edited video may include the frame corresponding to the timing. The instructor may input the timing by using an operation unit of the display terminal 3, or may input the timing by voice into a microphone of the display terminal 3. One example of the input voice is a predetermined trigger word such as “dangerous”.

(3) The edited video may include a screenshot at certain timing of a cooking video instead of a moving image.

(4) The processing of steps S104 to S106 shown in FIG. 13 may be omitted. In this case, the cooking utensil is not selected, and the lecture information is determined depending on the instruction level.

(5) The instruction level may be determined by using either the experience information or the comprehension level.

(6) When a sensor such as an acceleration sensor is attached to the cooking utensil, the generation unit 122 may generate additional information to support the evaluation based on sensor information and include the generated additional information in the evaluation assistance information. For example, when an acceleration sensor is attached to a kitchen knife, the generation unit 122 may measure the swing width of the kitchen knife from the sensor information of the acceleration sensor, and include additional information indicating that the method of handling the kitchen knife is unstable in the evaluation assistance information if the swing width is larger than a threshold.

(7) In the above embodiment, the cooking content is an action of cutting a food material, but may also be an action of boiling a food material. In this case, the processing of steps S104 to S106 shown in FIG. 13 may be omitted. Alternatively, in steps S104 to S106 shown in FIG. 13, instead of the processing of selecting the cooking utensil, the processing of selecting either an IH cooking heater or a gas stove is adopted.

In this modification, one example of the food material is a food material that can be boiled, such as egg, carrot, fish, and meat.

In this modification, the lecture information includes precautions for handling fire or heat. This precaution is, for example, appropriate heat power such as high, medium, or low heat, since areas other than a handle of a pot will become hot during heating, avoid touching those areas, and be careful with boiling water. When an IH cooking heater is selected, the precaution is being careful during heating because the surface of the IH cooking heater becomes hot.

(8) In the above embodiment, the cooking content is an action of cutting a food material, but may be an action of grilling a food material. In this case, the processing of steps S104 to S106 shown in FIG. 13 may be omitted. Alternatively, in steps S104 to S106 shown in FIG. 13, instead of the processing of selecting the cooking utensil, the processing of selecting either an IH cooking heater or a gas stove is adopted.

In this modification, one example of the food material is a food material that can be grilled, such as raw egg, tomato, fish, and meat.

In this modification, the lecture information includes precautions for handling fire or heat. This precaution is, for example, appropriate heat power such as high, medium, or low heat, since areas other than a handle of a frying pan will become hot during heating, avoid touching those areas, and be careful with heated oil. When an IH cooking heater is selected, the precaution is being careful during heating because the surface of the IH cooking heater becomes hot.

(9) The cooking content may include all of the action of cutting the food material, the action of boiling the food material, and the action of grilling the food material. In this case, in step S101, among a plurality of dishes that involves the action of cutting, the action of boiling, and the action of grilling (for example, curry, stew, and the like), cooking information indicating the dish selected by the user is acquired. In this case, the lecture information may be generated separately for each of the action of cutting, the action of boiling, and the action of grilling. Furthermore, if the action of cutting a plurality of food materials is included, the lecture information may be generated for each food material.

Regarding the evaluation assistance information, the evaluation assistance information may be generated separately for each of the action of cutting, the action of boiling, and the action of grilling, or the evaluation assistance information for the entire dish may be generated. The evaluation result may be an evaluation result of the entire dish, or an evaluation result of each of the action of cutting, the action of boiling, and the action of grilling.

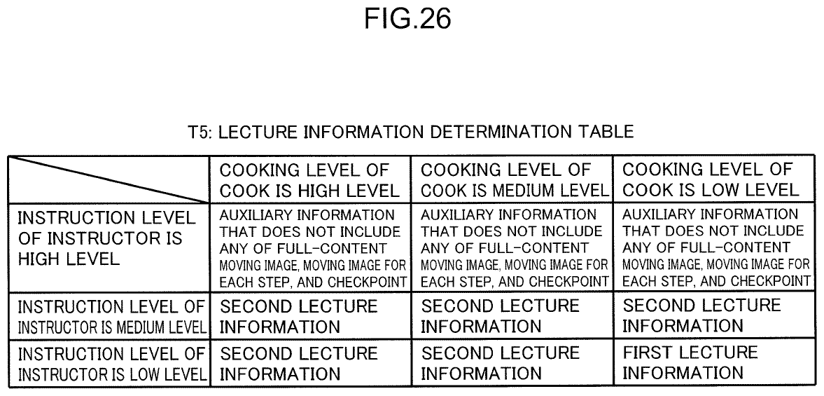

(10) In step S107, the generation unit 122 may change the lecture information to output depending on the combination of the instruction level of the instructor and the cooking level of the cook. FIG. 26 is a diagram showing one example of a lecture information determination table T5 for determining the lecture information. In the lecture information determination table T5, the vertical axis shows the instruction level of the instructor, and the horizontal axis shows the cooking level of the cook.

In the lecture information determination table T5, the auxiliary information is auxiliary information that does not include any of the full-content moving image, the moving image for each step, and the checkpoint, as described above.

In the lecture information determination table T5, the first lecture information is lecture information including the full-content moving image, the moving image for each step, and the checkpoint, as described above.

In the lecture information determination table T5, the second lecture information is lecture information that includes the checkpoint list that lists the checkpoints as described above, but does not include the full-content moving image and the moving image for each step.

When the instruction level of the instructor is the high level, the generation unit 122 generates the auxiliary information regardless of the cooking level of the cook. This is because the instruction level of the instructor is the high level, and the instructor can provide the cook with instruction on the method of cooking without relying on the lecture information.

When the instruction level of the instructor is the medium level, the generation unit 122 generates the second lecture information regardless of the cooking level of the cook. In this case, the instructor can properly provide cooking instruction by referring to the checkpoint included in the second lecture information as appropriate.

In a case where the instruction level of the instructor is the low level, when the cooking level of the cook is higher than the instruction level of the instructor, that is, when the cooking level of the cook is the high level or the medium level, the generation unit 122 generates the second lecture information. In this case, instead of the first lecture information matching the instruction level “low level”, the second lecture information, which is originally used when the instruction level is the medium level, is generated. When the cooking level of the cook is the high level or the medium level, it is assumed that the cook can cook without watching the full-content moving image and the moving image for each step. Therefore, the instructor only needs to secure the checkpoint as areas to instruct and check. Therefore, in this case, a second lecture image is generated instead of a first lecture image.

In a case where the instruction level of the instructor is the low level, when the cooking level of the cook is the low level, the generation unit 122 generates the first lecture information. This is because when both the cook and the instructor have the low level, the full-content moving image, the moving image for each step, and the checkpoint list are required.

Note that the cooking level of the cook is acquired by the acquisition unit 121. The acquisition unit 121 may acquire the cooking level by causing the cook or the instructor to input the cooking level via the user terminal 2. Alternatively, the acquisition unit 121 may acquire the cooking level by analyzing a moving image that shows how the cook is cooking.

(11) Assume a case where a cook who has passed cooking (for example, peeling using peeler) of a certain food material (for example, carrot) using a cooking utensil (for example, peeler) executes the same cooking (for example, peeling using peeler) of another food material (for example, Japanese radish). In this case, the generation unit 122 may generate the lecture information from which information regarding the cooking (for example, peeling using peeler) is omitted. For example, when applying the lecture B shown in FIG. 5 to the peeling of a Japanese radish by using the peeler, the generation unit 122 may generate the lecture information with the display of the lecture on safe usage of the peeler included in “peeling of step #2” omitted.

(12) The acquisition unit 121 may execute a confirmation test on the cook to confirm whether the cook understands the checkpoint, and acquire the test result of the confirmation test. Then, the generation unit 122 may identify the checkpoint the cook understands from the test result, and generate the lecture information with the identified checkpoint omitted. For example, when the cook understands the checkpoint of holding among the checkpoints displayed in FIG. 4, the generation unit 122 only needs to generate the lecture information with the checkpoint of holding omitted.

The present disclosure is useful in the technical field of assisting cooking.

1. An information output method comprising, by a computer:
acquiring cooking information including cooking content to be evaluated and an instruction level of an instructor;
generating assistance information when the instructor instructs, in cooking, a cook who executes the cooking content based on the cooking information and the instruction level; and
outputting the assistance information.

2. The information output method according to claim 1, wherein
the cooking information further includes cooking utensil information indicating a cooking utensil used for the cooking, and
the cooking content includes food material information indicating a food material used for the cooking.

3. The information output method according to claim 1, wherein
the cooking content includes at least one of an action of cutting the food material, an action of boiling the food material, and an action of grilling the food material.

4. The information output method according to claim 1, wherein
the instruction level is determined based on at least one of execution experience of the instructor in the cooking content, and a comprehension level of the instructor about instruction content when instructing the cook in the cooking.

5. The information output method according to claim 4, wherein
when the instructor does not have the execution experience of the cooking content, the generated assistance information includes the cooking content and the instruction content when instructing the cook in the cooking.

6. The information output method according to claim 1, further comprising acquiring a comprehension level of instruction content by the cook when the instructor has execution experience of the cooking content,
wherein when the comprehension level is equal to or less than a predetermined value, the generated assistance information includes the instruction content, and
when the comprehension level is greater than the predetermined value, the assistance information is not generated.

7. The information output method according to claim 1, further comprising:
acquiring execution information including a video photographed while the cook executes the cooking;
generating evaluation assistance information including the execution information based on the instruction level; and
outputting the evaluation assistance information.

8. The information output method according to claim 7, further comprising acquiring experience information indicating whether the instructor has execution experience of the cooking content,
wherein in generation of the evaluation assistance information, when the experience information indicates that the instructor does not have the execution experience, the generated evaluation assistance information includes the cooking content, the instruction content of the cooking by the instructor, and the execution information.

9. The information output method according to claim 8, further comprising acquiring a comprehension level of the instruction content by the instructor when the experience information indicates that the instructor has the execution experience,
wherein when the comprehension level is equal to or less than a predetermined value, the generated evaluation assistance information includes the instruction content and the execution information.

10. The information output method according to claim 7, wherein
outputting the assistance information includes outputting the assistance information while the cook executes the cooking content, and
outputting the evaluation assistance information includes outputting the evaluation assistance information after the cook executes the cooking content.

11. The information output method according to claim 10, further comprising:
acquiring an evaluation result of the cook by the instructor based on the evaluation assistance information; and
storing the evaluation result in a memory in association with the cooking content.

12. The information output method according to claim 1, wherein
acquiring the cooking information includes presenting at least one of the cooking content of which the cook does not have execution experience and cooking content of which evaluation by the instructor is an unachieved evaluation, and acquiring cooking information including cooking content selected based on the cooking content presented.

13. The information output method according to claim 1, further comprising acquiring a cooking level of the cook,
wherein generating the assistance information includes generating the assistance information based on the cooking information, the instruction level, and the cooking level.

14. An information output device comprising:
an acquisition unit that acquires cooking information including cooking content to be evaluated and an instruction level of an instructor;
a generation unit that generates assistance information when the instructor instructs, in cooking, a cook who executes the cooking content based on the cooking information and the instruction level; and
an output unit that outputs the assistance information.

15. A non-transitory computer readable recording medium storing an information output program for causing a computer to execute processing comprising:
acquiring cooking information including cooking content to be evaluated and an instruction level of an instructor;
generating assistance information when the instructor instructs, in cooking, a cook who executes the cooking content based on the cooking information and the instruction level; and
outputting the assistance information.
